(19) United States
(12) Patent Application Publication
(10) Pub. No.: US 2017/0092121 A1
(43) Pub. Date: Mar. 30, 2017

(54) Method and System for Determining and Using Property Associations

(71) Applicant: Bayerische Motoren Werke Aktiengesellschaft, Muenchen (DE)

(72) Inventor: Alexander AUGST, Muenchen (DE)

(21) Appl. No.: 15/279,672

(22) Filed: Sep. 29, 2016

(30) Foreign Application Priority Data
Sep. 30, 2015 (DE) 10 2015 218 967.8

(51) Int. Cl. G08G 1/01; G05D 1/02; G08G 1/0968; B60W 50/08; G08G 1/017; B60W 50/14; G08G 1/0967

(52) U.S. Cl. CPC G08G 1/0141; B60W 50/14; G05D 1/0285; G08G 1/096708; B60W 50/082; G08G 1/017; G08G 1/096855; B60W 2550/20

(57) ABSTRACT

A method for assigning sets of properties of one or more road users is provided. The method includes recording a first set of properties of a road user at a first instant of time using sensors of a vehicle and/or using sensors outside the vehicle, and recording a second set of properties of a road user at a second instant of time, which is after the first instant of time. The method also includes comparing properties of the first set and properties of the second set, and determines an assignment of the first and second sets to an assigned road user on the basis of the comparison. The assignment can be made available to the vehicle, for example.

### CROSS REFERENCE TO RELATED APPLICATIONS

This application claims priority under 35 U.S.C. §119 from German Patent Application No. 10 2015 218 967.8, filed Sep. 30, 2015, the entire disclosure of which is herein expressly incorporated by reference.

### BACKGROUND AND SUMMARY OF THE INVENTION

The invention relates to a method and a system for determining and using feature or property associations relating to road users, in particular in order to determine extended information relating to properties of road users (for example for use in vehicle functions).

Communication protocols and cooperative safety applications which are intended to enable cross-vehicle-manufacturer, cooperative and, if possible, accident-free driving in the future are currently standardized, within the scope of various initiatives relating to the topic of “Intelligent Transportation Systems” (ITS), inter alia, with the European standardization authorities ETSI and CEN and also with ISO, SAE and IEEE in the USA. The safety applications addressed and the associated transmission protocols and data formats are documented, inter alia, in the ETSI standard EN 302 637 and in the SAE standard SAEJ2735. The standard EN 302 637-2, for example, therefore defines a so-called cooperative awareness message (CAM) which is transmitted at periodic intervals by an ITS station (for example a vehicle) in order to inform another ITS station (for example a so-called ego vehicle) in the environment of selected information (for example speed, acceleration and/or position) relating to the transmitting ITS station. The information interchanged between the ITS stations, for example using CAM messages, can be used in the respective ITS stations to identify risks of collision and possibly to initiate suitable countermeasures (for example warnings).

The information which can be transmitted to an (ego) vehicle using an ITS message is limited or restricted, however. The present document deals with the technical object of providing a method and a corresponding system which can be used to provide an ego vehicle with extended information relating to a traffic situation and, in particular, relating to a road user in the environment of the (ego) vehicle.

This and other objects are achieved in accordance with embodiments of the invention.

One aspect describes a method for assigning sets of properties of one or more road users. The method comprises recording a first set of properties of a road user at a first instant of time. The first set of properties can be recorded using systems or devices of a vehicle (for example using an environmental sensor of the vehicle) and/or using systems or devices outside the vehicle (for example using an environmental sensor of an infrastructure unit or of another vehicle). The method also comprises recording a second set of properties of a road user at a second instant of time. In this case, the first instant of time has a time shift with respect to the second instant of time. The second set of properties can be recorded using systems or devices of a vehicle (for example using an environmental sensor of the vehicle) and/or using systems or devices outside the vehicle (for example using an environmental sensor of an infrastructure unit or of another vehicle). The two sets of properties can therefore comprise properties of the same road user at different times and possibly from different perspectives.

The method also comprises comparing properties of the first set and properties of the second set. The method also comprises determining an assignment of the first and second sets to an assigned road user on the basis of the comparison. In particular, during the comparison, it is possible to determine whether the properties from the first and second sets have a relatively high degree of similarity or correlation. If this is the case, both sets of properties can be assigned to the same road user (that is to say a common “assigned” road user). The assignment of the two sets of properties can then be provided directly or indirectly (for example for a vehicle function in the vehicle).

In this case, the determined assignment can be provided in a memory of the vehicle or in a memory outside the vehicle, for example in an infrastructure apparatus. Alternatively or additionally, a property of a road user (in particular of the assigned road user) can be provided on the basis of the assignment. Depending on the determined assignment, at least one or more particular properties of one or more particular road users can be provided, for example, using means of the vehicle or using means outside the vehicle.

The method makes it possible to reliably provide extended data for a road user (for example for another vehicle in the environment of the vehicle) even without having to accurately identify the road user. In particular, extended data which were recorded at an (earlier) first instant of time can be provided at a (subsequent) second instant of time.

The assignment determined in the method can be provided for one or more functions of the vehicle, in particular for a driver assistance function, and/or for the purpose of optimizing a movement of a plurality of vehicles, for example the vehicles of a particular brand.

The method may comprise determining a property of the assigned road user, which cannot be recorded to a required extent, for example with sufficient reliability, at the second instant of time, on the basis of the assignment. In particular, the first set of properties can provide at least one property of the assigned road user which is not contained in the second set of properties. This extended information can be used for a vehicle function, for example.

A period of 5, 10, 20, 30, 60 seconds or more may lie between the first instant of time and the second instant of time. In this case, properties of the assigned road user may possibly not be recorded at least temporarily between the first instant of time and the second instant of time. Nevertheless, a reliable assignment can be made by means of the combined comparison of a plurality of properties.

The comparison and/or the determination of an assignment may comprise the recognition of a road user. Furthermore, a process of tracking the assigned road user can be carried out on the basis of the assignment. Reliable environment monitoring can therefore be carried out even if recording of a road user is temporally interrupted.

The method may also comprise determining a third set of properties of the assigned road user on the basis of the comparison, and providing the third set in the vehicle and/or in another road user. In particular, the third set may comprise properties from the second set which are not included in the first set (or vice versa). Extended information relating to the assigned road user can therefore be efficiently made available to the vehicle, for example.

The comparison of properties of the first set and properties of the second set may comprise determining a degree of similarity; determining one or more statistical dependencies between properties; and/or determining a degree of plausibility. Sets of properties can therefore be reliably assigned.

The comparison and the determination of an assignment may comprise determining a machine-trained allocation function, in particular a neural network, which is set up to determine whether or not a first set of properties and a second set of properties belong to the same road user. The use of machine-trained allocation functions makes it possible to efficiently and reliably assign sets of properties.

The comparison and the determination of an assignment may comprise determining a data model for a road user, a data model being able to indicate probabilities for combinations of properties. The comparison and the determination of the assignment can then be carried out on the basis of the data model. In particular, the comparison and the determination of an assignment can be carried out on the basis of a multiplicity of data models for different combinations of properties. It is therefore possible to reliably assign sets of properties to particular road users.

The method may also comprise determining an input variable for at least one vehicle function of the vehicle on the basis of the comparison and/or the assignment. In this case, the input variable may possibly be determined outside the vehicle. Vehicle functions can therefore be efficiently provided in a vehicle.

The vehicle function may preferably be a driver assistance function. The input variable may be information and/or an instruction used to influence the movement of one or more vehicles. For example, the input variable may directly or indirectly relate to specific maneuvering decisions, route planning or movement trajectories of the vehicle, in particular with respect to a road user. For example, the input variable for a vehicle function may represent one or more recommended and/or non-recommended driving instructions relative to one or more road users. Such relative driving instructions may be, in particular: follow a road user, overtake a road user, drive at a distance, etc. The input variable may also represent a relationship between movement planning for the vehicle (to be followed or avoided) with respect to a further condition or a further object outside the vehicle.

The first set and/or the second set may comprise properties from one or more of the following categories: geometrical data relating to a road user; color information relating to a road user; information relating to the clothing of a pedestrian or a driver of a vehicle; a class of a road user; a model or a series or a vehicle model of a vehicle; and/or information relating to a vehicle brand of a road user. Alternatively or additionally, the first set and/or the second set may comprise properties from one or more of the following categories: absolute and/or relative position data relating to a road user; absolute and/or relative movement data relating to a road user; and/or geometrical arrangement data relating to a road user relative to at least one other road user. Alternatively or additionally, the first set and/or the second set of properties may comprise one or more of: information relating to a license number of a road user; information relating to a vignette of a road user; and/or information relating to an electronic device which is moved with the road user. In this case, the vignette may also be a machine-readable code which is fitted to the vehicle or is produced using means of the vehicle. This code may also be used for one or more other purposes.

In this case, the brand of a vehicle can be detected, for example, on the basis of the recording of a brand emblem of a road user using a camera of the (ego) vehicle or using means outside the vehicle, for example using a camera of an infrastructure apparatus, for example on a freeway bridge.

The first set and the second set may at least partially comprise different properties, in particular properties from different categories.

The values of corresponding features (that is to say corresponding properties) may possibly be directly compared. In one preferred configuration of the method, at least one measure is stipulated for a plurality of combinations of one or more properties from the first set of properties and from the second set of properties. This measure may comprise a degree of similarity, plausibility or the addition of at least one data model. A different suitable measure may possibly be used for each property.

In particular, the assignment may be made on the basis of a matrix which predefines, for the first set of properties and for the second set of properties, which comparison operations need to be carried out between the respective types of properties and/or how a result of the comparison operation influences an assignment between the first set of properties and the second set of properties.

In one example, a combination is determined from a plurality of degrees of similarity, degrees of plausibility and measures which represent an addition of a particular data model. Furthermore, on the basis of the determined measures, it is possible to use a simulated neural network, for example, to decide how and/or whether a particular first set of properties and a second set of properties should be assigned.

The decision relating to the assignment of the first set of properties and the second set of properties may also be made on the basis of the further conceivable variants of an assignment. For example, the matching values which are in favor of and/or against a particular assignment are determined for at least two conceivable assignment variants. It is then possible to determine one or more assignments in which the highest matching values are achieved or in which a cumulative value of a plurality of matching values, which is determined according to a predetermined method, is the greatest.

An assignment can be determined on the basis of data which indicate which road users are in a particular road section. The quality of assignments can therefore be increased further.

The first set of properties can be at least partially determined by querying a database outside the vehicle and/or by comparing data from a multiplicity of means outside the vehicle. The scope of the data provided can therefore be increased further.

A road user may have one or more permanent properties and one or more variable properties. In this case, variable properties can be represented by their current qualitative or quantitative value or state. An assignment can be determined on the basis of the one or more current or variable properties and on the basis of the one or more permanent properties. The quality of the assignment can be increased by taking into account different types of properties.

The method may comprise transmitting a query message by systems or devices of the vehicle, the query message comprising information which depends on the first set of properties. Therefore, information relating to road users which has been extended only on request may possibly be provided, thus making it possible to reduce a volume of data. In this case, the transmission may comprise direct or indirect transmission of the corresponding information by means of at least one wireless data connection.

First sets of one or more road users can be primarily provided by the systems or devices outside the vehicle in response to the query message, which sets are indicated in the query message or are associated with an indicated road user. Alternatively or additionally, the query message can indicate one or more properties which are intended to be recorded by the systems or devices outside the vehicle. The data traffic and the loading of resources can therefore be reduced further.

The method may comprise determining one or more associated road users associated with the assigned road user. It is then possible to provide data for the one or more associated road users. Associated road users may be road users which are associated with the (ego) vehicle or with one another in a particular manner in the current interval of time. For example, they may be vehicles having a direct relationship to a manoeuver (lane change manoeuver, overtaking maneuver, positioning manoeuver, turning manoeuver, mutual merging manoeuver, etc.). Associated road users may be road users which can (at least potentially) hinder or help one another during a driving action. The vehicle can therefore be provided with an image of a traffic situation which is as comprehensive as possible, in particular a selected part of the traffic situation relating to the vehicle in a relevant interval of time. In this case, (mutual) transmission and processing of relatively large volumes of data can also be avoided.

The method may also comprise comparing the first set of properties with the second set of properties. Alternatively or additionally, it is possible to create an environmental model of the vehicle on the basis of the first and second sets of properties.

The first set of properties, the second set of properties and/or the third set of properties may be used by the vehicle to drive the vehicle at least partially in an automatic manner; and/or to output an item of driver information to a driver of the vehicle; and/or to output a handling instruction and/or a warning with respect to the assigned road user and/or with respect to an associated road user to the driver of the vehicle.

Another aspect describes a computer program, in particular a computer program product. The computer program may possibly be directly loaded into the internal memory of a digital apparatus (in particular an electronic control unit of a driver assistance system in a vehicle having a computing unit). The computer program may also comprise software code sections which are used to carry out the steps of the method according to one of the method claims described when the computer product runs on the digital apparatus. In this case, different computer programs may be provided for an external unit, for a vehicle and/or for a user terminal.

Another aspect describes a system for assigning sets of properties of one or more road users. The system comprises a computing unit which is set up to record a first set of properties of a road user at a first instant of time using systems or devices of a vehicle and/or using systems or devices outside the vehicle. The computing unit is also set up to record a second set of properties of a road user at a second instant of time, the second instant of time having a time shift with respect to the first instant of time. The computing unit is also set up to compare properties of the first set and properties of the second set; to determine an assignment of the first and second sets to an assigned road user on the basis of the comparison; and to provide the assignment. Furthermore, the system may also be configured to carry out further features of the method which are discussed above.

Another aspect describes a vehicle which is set up to carry out vehicle-side method steps of the method described in this document. The vehicle may be, in particular, a multi-track road vehicle or a motorcycle.

Another aspect describes an external unit (outside the vehicle) which is set up to carry out the method steps of the method described in this document which are carried out by the external unit.

The method mainly discussed here from the point of view of an (ego) vehicle can be mutually used for a multiplicity of the road users in such a manner that a multiplicity of the road users simultaneously or alternately have a role of the “ego vehicle”. In this case, it is possible, for example, to gradually optimize the safety or the consistent driving style of the road users participating in the method. Furthermore, the method can also be used to optimize a driving style of a particular group of vehicles, for example the participants in the method or vehicles of a particular brand or with particular equipment.

It should be borne in mind that the methods, apparatuses and systems described in this document can be used both alone and in combination with other methods, apparatuses and systems described in this document. Furthermore, any aspects of the methods, apparatuses and systems described in this document can be combined with one another in various ways. In particular, the features of the claims can be combined with one another in various ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a block diagram of an exemplary system for determining associations between sets of properties of a road user; and

FIG. 2 is a flowchart of an exemplary method for determining associations between sets of properties of a road user.

### DETAILED DESCRIPTION OF THE DRAWINGS

As explained at the outset, the present document deals with the technical object of providing an ego vehicle with information relating to one or more road users which is as comprehensive as possible. Extended driver assistance systems, in particular partially automated and highly automated driving, can therefore be provided in a reliable and robust manner in the ego vehicle.

Vehicle functions, such as partially automated and highly automated driving, impose high demands on the recording of the environment of an ego vehicle and therefore on the environmental sensors installed in the ego vehicle (for example cameras, radar, ultrasound, LIDAR, etc.). However, even complicated environmental sensors typically cannot record all properties of other road users which would be useful for reliably providing particular vehicle functions. This is due to the fact, in particular, that the recording perspective of the environmental sensors is restricted from the point of view of the ego vehicle. In particular, the recording perspective of the environmental sensors (that is to say the on-board sensor system) of an ego vehicle typically corresponds approximately to the viewing perspective of a driver of the ego vehicle. The ego vehicle can therefore typically be provided with information which cannot be perceived from the viewing perspective of the driver only to a limited extent (in particular with regard to a property of another road user and/or with regard to an associated traffic situation) via its own environmental sensors.

In particular, the situation may occur in which an object (in particular another road user) leaves the recording range of a sensor. In this case, continuation or resumption of tracking of the object is typically difficult and is not very reliable. Therefore, reliable tracking is currently possible only in the case of virtually uninterrupted sensor recording. Consequently, a vehicle can typically use only information with respect to objects which can be recorded at a current instant time. It is therefore scarcely possible to reliably infer particular properties of an object (in particular another road user) which currently cannot be recorded by means of sensors.

The present document describes a method which makes it possible to use data collected from an ego vehicle or from other vehicles or from an infrastructure apparatus within a certain time in the (recent) past by storing and reusing the associations for at least partially automated or highly automated driving.

In this case, the fundamental concept is that one or more property sets relating to the properties of a road user are recorded, for example using the vehicle's own sensor system or environment recording, on the basis of data from other vehicles and/or on the basis of data recorded by way of sensors from an infrastructure apparatus, for example a freeway bridge. These one or more property sets can comprise information which has already been preprocessed or interpreted (for example using a computing unit of the vehicle) and relates to the mutual associations between the properties.

At another time, a current property set relating to the properties of a road user or a current traffic situation can be recorded. The current property set may comprise properties which can be currently measured or detected. The current property set can then be compared with one or more of the property sets from the past. Property sets for the same road users and/or for related traffic situations are therefore found and assigned.

In particular, one or more (particular) road users can thus be recognized. In this case, particular properties of the road users (including those which currently cannot be recorded) can be assigned and can be extracted on the basis of the assignment. Extended information relating to a road user can therefore be provided.

A decision relating to an assignment of a first property set (at a past time) and a second property set (at a current time) can therefore be made. In this case, the decision relating to an assignment can be made on the basis of the similarity of the properties which form an intersection between particular properties of the first property set and corresponding properties of the second property set. In this case, positive and/or negative criteria can be taken into account. Alternatively or additionally, the decision relating to the assignment between the property sets can be made according to a principle of the plausibility of a resulting model of the assigned property sets.

Furthermore, associations or correlations between property sets, which are independent of an item of movement information and currently cannot form an expedient controlled variable, for example for driver assistance systems, vertical dynamics systems, etc., can be used in the described method. A correlation may also be a correlation between two functions which indicates a change in at least one variable property of a road user.

In certain situations, a property which is recorded using the sensor system of the vehicle, for example a color of a road user, and in itself is not a usable item of useful information for driving a vehicle, can be used to assign an item of useful information relating to a particular road user and to use this assigned item of useful information to drive the vehicle or for another vehicle function. For example, a real maneuvering decision or control decision for a highly automated or partially automated vehicle may therefore be made on the basis of a helmet color of a motorcyclist recorded using the camera of the highly automated or partially automated vehicle. In particular, an assignment to a second property set can be made on the basis of the recorded helmet color, information from the second property set being able to be used for the maneuvering decision.

At least one of the property sets can be determined using an external sensor system or using a sensor system of another vehicle. This sensor system may record a traffic situation from a different perspective and/or at a different time, for example.

Assigning property sets means that, during a driving action decision, for example a maneuvering decision, the vehicle can therefore have extended information relating to the surrounding traffic situation and/or relating to a traffic situation in the near future in comparison with the information which can be provided using the perceptive means or IT means of the vehicle. This extended information can be provided in the vehicle and can be advantageously used for vehicle functions and/or for informing the driver.

The property sets can be compared in one or more vehicles or, for example, in a wireless router (WLAN, LTE, etc.) on a freeway bridge or in a backend. In this case, data from the compared property sets can be selectively sent. In particular, only the assigned property sets relevant to a road user or information derived therefrom can be transmitted to said road user. The quantity of interchanged data can therefore be reduced.

This document therefore describes a method for comparing the properties of road users, in particular for determining properties of one or more road users or associated control information. Furthermore, a corresponding system, further means and a corresponding computer product are described.

In particular, a method suitable for using feature associations for a vehicle function, in particular for at least partially automated driving, is described. The method comprises recording one or more first sets of properties of one or more road users using systems or devices of a vehicle or using systems or devices outside the vehicle. The one or more first sets of properties may have been recorded at one or more past times. The method also comprises recording at least one second set of properties of one or more road users at a current instant of time.

The method also comprises comparing the properties from a first set of properties of one or more road users with the second set of properties of one or more road users. The method also comprises determining an assignment between one or more first sets of properties and the second set of properties and providing the assignment or data, which are dependent on this assignment, in a memory. In this case, the at least one first set of properties relates to the past.

The recorded one or more first sets of properties may be stored and may be read from the memory. The second set of properties may represent properties of a road user recorded and processed substantially in real time. These may be, for example, <0.1 seconds to a few seconds old. A first set of properties may relate, in particular, to the last 5, 10, 100 seconds or a few minutes before a current time.

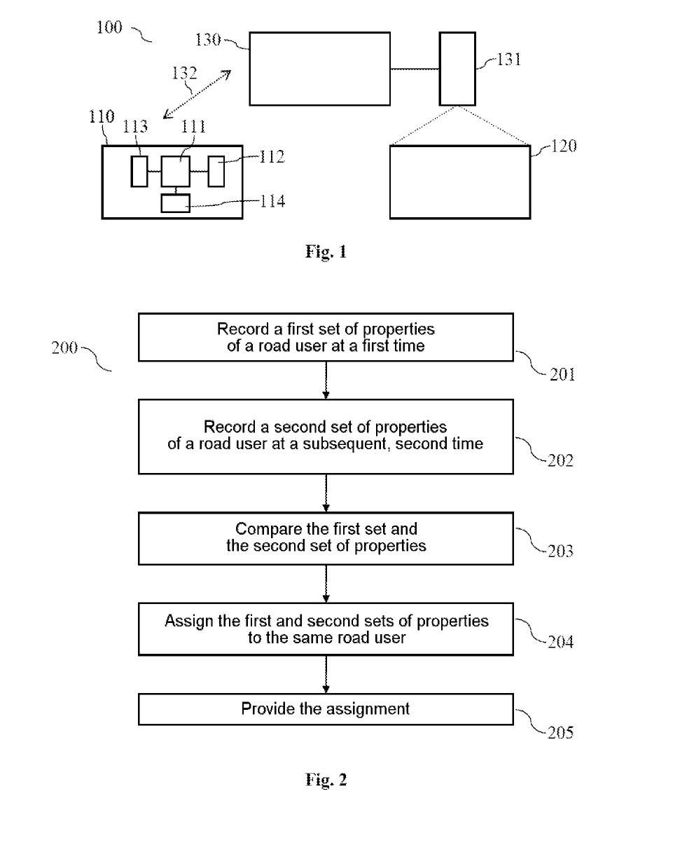

FIG. 1 shows an exemplary system 100 for determining properties relating to a road user. The system 100 comprises an ego vehicle 110 which is in a traffic situation with a road user 120. The ego vehicle 110 comprises at least one environmental sensor 112 (generally also referred to as systems or devices inside the vehicle) which is set up to record environmental data relating to an environment of the ego vehicle 110. In particular, the environmental sensor 112 may be set up to record environmental data relating to the road user 120. A control unit or computing unit 111 of the ego vehicle 110 may be set up to determine one or more property sets (or a set of properties) relating to the road user 120 on the basis of the environmental data.

The system 100 may also comprise a unit 130, 131 outside an ego vehicle 110 (referred to as an external unit for short), the unit 130, 131 comprising at least one sensor 131 (for example a camera, a radar sensor, an ultrasonic sensor, etc.) for recording sensor data in a particular environment (for example in a particular road section). The sensor 131 may also be generally referred to as systems or devices outside the vehicle 110. The sensor 131 may be set up to record a road user 120. For example, a camera can be used to record image data which indicate a road user 120 (for example a vehicle). The external unit 130, 131 comprises a processing unit or computing unit 130 (for example a server) which is set up to evaluate the sensor data from the at least one sensor 131. In particular, the external unit 130, 131 may be set up to determine one or more property sets (or a set of properties) relating to the road user 120 on the basis of the sensor data.

The systems or devices inside the vehicle 110 (or an apparatus inside the vehicle) may comprise, for example, a vehicle sensor system or a corresponding additional device (or accessory) which moves with the vehicle 110. Properties from the first set of properties may comprise processed and/or interpreted data which have been determined on the basis of the recording of the environment by means of sensors.

The systems or devices outside the vehicle 110 (or the apparatus outside the vehicle) may comprise an infrastructure sensor system, a sensor system of another vehicle or other known or future apparatuses. The use of systems or devices outside the vehicle 110 is advantageous since such systems or devices outside the vehicle 110 typically are not subject to the strict weight, cost, energy consumption and environmental resistance criteria which apply to vehicles. This enables savings and degrees of freedom for a high data quality. The described method does not require any permanent recording of a road user 120 using the systems or devices outside the vehicle 110. For example, recording can be carried out at freeway bridges which are spaced apart.

The one or more road users 120 may be road users in the vicinity of a (user) vehicle 110. In this case, a vehicle may possibly be the user or ego vehicle 110 and the road user 120 at the same time.

Properties of a road user 120 can be recorded using systems or devices 131 outside the vehicle 110 from at least two different perspectives (and possibly using a plurality of means or sensors). For example, contours of the road user can be recorded from two or more perspectives, in particular: substantially from above, substantially from the side, and/or substantially from the front.

The properties of a road user 120 can be determined or aggregated from a plurality of such contours and further information. For example, the properties of a road user 120 may comprise a simplified 3-D model, for example of the external dimensions of the road user 120. Many different properties can be determined, including those which are currently not used for partially automated driving of a vehicle.

The first property set and the second property set may be recorded in real time, in particular.

The comparison and/or the assignment can be carried out according to predefined criteria. A first set of properties can be compared with one or more sets of second properties using a matrix, for example, which is configured to assign suitable or most suitable sets of properties (to one another).

In this case, the comparison can be configured in such a manner that the most suitable combinations of properties are assigned to one another in each case. Since a complete match is statistically rather rare, methods are described below for determining a correct assignment on the basis of a multiplicity of partially matching properties.

In particular, the property sets which each relate to the same interval of time or represent virtually the current conditions can be compared and assigned.

A comparison and/or an assignment can be made inside an infrastructure apparatus, for example in a memory of a backend and/or a cloud and/or an Internet portal.

Within the scope of the method described, only or predominantly data relating to at least one or more (particular) road users 120 in the environment of the vehicle 110 are particularly preferably provided.

The method described makes it possible to ensure that the items of identification information recorded using systems or devices outside the vehicle 110 and using systems or devices inside the vehicle 110 can be assigned to one another (one-to-all, all-to-one, one-to-one).

The memory 114 in which the data for comparing the sets of properties of a road user 120 are provided may be situated in the vehicle 110, in another vehicle and/or in an infrastructure apparatus 130, 131 (for example in a server on a freeway bridge).

In one exemplary use of the method described, the sensor system 112 of a vehicle 110 records a front part of a road user 120 traveling behind. A first set of properties can therefore be recorded and stored for the road user 120. The first set of properties can indicate, for example, the shape, the size and/or the nature of the front part of the road user 120. The first set of properties may comprise data which have already been interpreted.

The road user 120 may substantially disappear from the recording range of the vehicle sensor system 112 for a particular interval of time (for example >5, 10, 30 seconds), for example on account of a manoeuver, concealment, etc. At a subsequent time, there may be a further encounter with the road user 120, for example in an overtaking operation, at an intersection during a different traffic situation (for example 10-120 seconds later). At this time, the sensor system 112 of the vehicle 110 can record only the rear part or a side part of the road user 120 and can determine data relating to this road user 120. A second set of properties can therefore be recorded.

A first set of properties was already determined at a preceding time, said set indicating, for example, data relating to the front part of the road user 120, data relating to the color of the road user 120, type or nature of the rims, the brand emblem, etc. Since the properties of the first set of properties also occur (at least in a similar form) in the second set of properties of the road user 120, the data which are now missing (for example the data relating to the front part of the road user 120) can be retrieved or reconstructed again. In this case, a 3-D model of a road user 120 (matching the currently recorded rear part) can also be reconstructed and provided, for example.

Data relating to properties which currently cannot be recorded by means of sensors for the vehicle 110 can therefore be made available in the (ego) vehicle 110. In this case, a completed model of another road user 120 can be optionally determined and provided in the vehicle 110. In particular, the method described can be used to determine properties of a road user 120 which are “complementary” to the properties which can be currently recorded. In this case, at least one first set of properties can be recorded or processed using means of other vehicles or using an infrastructure apparatus, for example at a freeway bridge, traffic lights, tunnel entrance.

FIG. 2 shows a flowchart of an exemplary method 200 for assigning sets of properties of one or more road users 120. The method 200 comprises recording 201 a first set of properties of a road user 120 at a first instant of time. This can be carried out using systems or devices 112 of a vehicle 110 and/or using systems or devices 131 outside the vehicle 110. The method also comprises recording 202 a second set of properties of a road user 120 at a second instant of time, the first instant of time and the second instant of time having a time shift with respect to one another. The method 200 also comprises comparing 203 properties of the first set and properties of the second set. An assignment of the first and second sets to a common assigned road user 120 is determined 204 on the basis of the comparison. The determined assignment can then be provided 205 (for example in a memory).

Exemplary aspects of the method 200 for comparing properties of road users 120, of the corresponding system 100 and of a corresponding computer product are shown below.

On the basis of a comparison and/or the assignment of at least one first set of properties with or to a second set of properties, it is possible to determine particular properties of a road user 120 which cannot be determined by means of sensors from a current geometrical arrangement of the ego vehicle 110 and of the road user 120. In particular, a property which is not part of the second set of properties (but is part of the first set of properties) can be determined.

These properties can then be provided in the ego vehicle 110, in particular for a vehicle function. At least one item of control information for a vehicle function, for example also in a remote computing unit, can also be determined on the basis of the determined property and can be wirelessly transmitted to the ego vehicle 110. In this case, further properties (for example from a different recording perspective), in particular relating to a different (complementary) side of the road user 120, which were previously recorded (for example using means of the vehicle 110) can be retrieved, for example. In this case, there is no need to explicitly identify the road user 120.

In the method 200, at least a period of 5, 10, 20, 30, 60 seconds may lie between the determination of a first set of properties and a second set of properties of the road user 120, in which period it is not possible to sufficiently record one or more properties of the road user 120 solely from the first set of properties or from the second set of properties of the road user 120.

For example, depending on a comparison or an assignment of a first set of properties of a road user 120 with a second set of properties of the road user 120, a road user 120 can be recognized and/or a tracking operation can be supported or resumed in the method 200.

As a result, a road user 120 already recorded by means of sensors 1 minute ago in a situation can be recognized as such, for example. In particular, the data collected for this road user 120 can be used for further tracking, for example.

One or more first sets of properties and one or more second sets of properties can be compared or assigned on the basis of a determined degree of similarity, one or more statistical dependencies and/or a degree of plausibility.

In this case, two or more items of external identification information (which have been obtained from a second set of properties) can be assigned to two or more items of vehicle-side identification information (which have been obtained from a first set of properties) on the basis of a maximum and/or minimum degree of similarity and/or on the basis of mutual completion and/or plausibility. A (complete) match of the external identification information and the vehicle-side identification information is not required in this case for carrying out the method 200. This would not be feasible in practice on account of a large amount of blurring, interference and a multiplicity of recording perspectives.

At least two corresponding measures (preferably degrees of similarity, degrees of plausibility) are particularly preferably determined for two or more possible assignments of a first set of properties and a second set of properties. At least one corresponding pair of a first set of properties and a second set of properties can then be assigned and provided on the basis of the degrees of plausibility determined.

Examples of the use of statistical dependencies are: general statistical information (for example how frequently red vehicles overtake in the speed range of 70-130 km/h); specific statistical information within a route (how frequently a green vehicle of a particular brand has already overtaken within a particular road section).

TABLE 1

| | Feature A | Feature B | Feature C | Feature D | Feature E |
|---|---|---|---|---|---|
| Feature A | similar | | | | matching |
| Feature B | | similar | matching | | |
| Feature C | | matching | similar | | |
| Feature D | | | | similar | |
| Feature E | matching | | | | similar |

Table 1 shows a first set of properties (features A to E in the horizontal direction) and a second set of properties (features A to E in the vertical direction). The values of corresponding features can be directly compared. A similarity is determined in the above-mentioned example. Furthermore, for different features, it is possible to determine whether the values could fundamentally match one another or are plausible. In total, a degree of similarity and/or a degree of plausibility between the first set of properties and the second set of properties can therefore be determined. Furthermore, the degree of similarity and/or the degree of plausibility can be taken as a basis for deciding whether the first set of properties and the second set of properties should be assigned to one another (and whether the two sets of properties should be assigned to the same road user 120).

Properties can therefore be determined and provided as an item of useful information for controlling one or more vehicle functions, in particular for controlling at least partially automated driving. The useful information can be determined on the basis of the comparison of the properties which by themselves do not allow any direct or one-to-one conclusions with regard to a current movement of a road user 120.

Comparing a multiplicity of properties of the first and second sets of properties, which each alone may have a relatively low confidence, makes it possible to achieve a comparatively high confidence of the assignment and therefore of the useful information obtained.

A first set of properties and a second set of properties can be compared or assigned in such a manner that a degree of matching is increased. This can be carried out, in particular, when particular assignments of individual properties have a particular type of positive dependence on a determined degree of similarity and/or when particular assignments of individual properties of a particular type have a negative dependence on a determined degree of similarity.

In other words: the degree of matching can increase if there is an increased degree of similarity of a group of properties and/or if a low degree of similarity or a high degree of dissimilarity of a further group of properties is determined.

A comparison and/or an assignment can be carried out using a neural network which has been accordingly set up or conditioned.

One or more first sets of properties and one or more second sets of properties can be compared and/or assigned on the basis of a determined completion of a data model, in particular a data model of a road user 120. For example, a database representing statistically occurring, probable or improbable combinations of features of road users 120 can be used to decide whether or how well a particular item of external identification information (that is to say a feature from the second set of properties) and a particular item of vehicle-side identification information (that is to say a feature from the first set of properties) match one another, in particular whether and how well the respective features together result in a combination which is plausible for a road user 120.

Sets of properties can be compared and/or assigned on the basis of a database representing a multiplicity of data models. Such a database can represent typical, probable, matching combinations of properties.

In this case, matching or simulated merging of a first set of properties or a second set of properties can be carried out to form a data model which was recorded at an earlier time, for example using systems or devices outside the vehicle, for example when a road user enters a road section, and/or corresponds to a statistical data model and/or can be retrieved from a remote computing unit (backend, cloud, Internet).

Such a database can be carried along with the vehicle 110 or in a mobile user device or the database can be retrieved from a remote computing unit.

The method can comprise determining an input variable for one or more vehicle functions for one or more vehicles. The input variable can be determined on the basis of the comparison or the assignment. The input variable for one or more vehicle functions may represent in this case a parameter set for operating and/or configuring a vehicle function. Alternatively or additionally, the input variable may comprise an item of control information for directly or indirectly controlling a vehicle function.

The input variable for one or more vehicle functions may be determined on the basis of the comparison of a first set of properties and a second set of properties and may represent the following: an intervention decision for at least partially automated intervention in a chassis of a vehicle (for example steering intervention, braking intervention, acceleration intervention at particular intervals of time, positions, etc.); a maneuvering decision (for example a lane change manoeuver, an evasion manoeuver, an overtaking maneuver, a parking manoeuver, a turning manoeuver, a positioning manoeuver, a spot braking manoeuver, etc.); information for the driver of a vehicle, in particular recommended actions (for example graphical, acoustic warnings, direction-dependent kinesthetic information, etc.). These input variables particularly preferably relate to specific intervals of time and positions of the vehicle 110.

As an alternative or in addition to explicit information relating to the properties of another road user 120, information which has already been previously interpreted by an external computing unit or control information can therefore be transmitted to the vehicle 110. The external evaluation may result in synergies since an interpretation of the assigned properties can also be used for a plurality of vehicles.

The input variable for one or more vehicle functions can be determined on the basis of one or more properties from a third set of properties (see further below).

The first set of properties and/or the second set of properties may comprise one or more of the following information categories (alone or in combination): geometrical data relating to a road user 120, in particular geometrical proportions or design features of the externally visible parts of the road user 120; an item of color information, for example relating to a color or color combination of a road user 120; an item of information relating to clothing of a pedestrian or a driver, in particular a cyclist; a class of the road user 120 (for example truck, automobile, motorcyclist, etc.); a brand or a specific model of a road user 120 (in particular a vehicle).

The geometrical proportions may be, for example, specific proportions, for example design proportions of the externally visible parts of the vehicle. A brand of the vehicle can be identified, for example, by detecting a brand emblem, a logo, etc., for example by means of a camera.

A relatively reliable statement regarding further properties of the road user 120 can be made from the totality of the comparisons of such properties. In this case, it is not necessary for the properties to allow a direct statement regarding physical or traffic-related properties of a road user 120.

In particular, one or more properties may be an item of distinguishing information which distinguishes a particular road user 120, in particular distinguishes one or more further road users 120 or renders the latter distinguishable.

One or more properties preferably comprise one or more quantitative measures of a respective property.

The first set of properties and/or the second set of properties may comprise one or more of: absolute and/or relative position data relating to a road user 120; absolute and/or relative movement data relating to the road user 120; and/or geometrical arrangement data in relation to one or more road users.

At least one property of at least one road user 120 may comprise an item of information dependent on: a license number of the road user 120 and/or an item of vignette information and/or a SIM card number or a device MAC number of an electronic device moved with the road user 120.

The properties in the first set of properties and the properties in the second set of properties may at least partially belong to different types or categories. In other words, the first set of properties and the second set of properties may have properties from different categories.

Sets of properties can be compared and/or assigned on the basis of a database comprising an item of information relating to a plurality of road users 120 situated in the road section with a sufficient degree of probability. Prior knowledge of possible road users 120 in a road section can therefore be taken into account in order to increase the quality of the assignment.

For example, the first sets of properties of all road users 120 entering a road section can be recorded from a freeway bridge. The vehicle 110 can determine a second set of properties approximately 1000 meters on. The two sets of properties can be compared and possibly assigned to one another on the basis of predetermined criteria. On the basis of the assignment, the properties relating to a road user 120 which are each missing in the vehicle 110 or an item of control information can be transmitted.

On the basis of the data made available to a vehicle 110, one or more of the following actions can be carried out: varying the at least partially automated movement of the vehicle 110 and/or outputting an item of information to the driver of the vehicle 110 on the basis of the determined properties; and/or a maneuvering decision relating to a manoeuver to be carried out in the near future; and/or a decision relating to the required degree of co-operation of the driver of the vehicle 110 in the near future. In particular, it is possible to make decisions relating to a takeover of longitudinal guidance and/or transverse guidance of the vehicle 110 by a driver, for example for a particular interval of time.

The method 200 may comprise recording one or more permanent properties of at least one road user 120 (as part of the first/second set of properties), for example using systems or devices 131 outside the vehicle. This can be at least partially carried out by querying a database and/or by means of a data comparison using other means 131 outside the vehicle. For example, an external unit 130, 131 at a current freeway bridge may compare or merge the properties of a road user 120 with the external unit 130, 131 of a previous freeway bridge.

The recorded properties of a road user 120 may comprise a permanent property and/or a variable property and/or a relative property with respect to a particular different vehicle.

Permanent properties of the road user 120 may comprise, for example: technical characteristics such as the (external) contour, the weight, the maneuverability, a fixed or variable form (for example a contour which is variable in the case of caravans or semitrailers), a brand, and/or a model, etc. of the road user 120. In this respect, the information may also belong to a class of the road user 120 (automobile, truck, motorcyclist, pedestrian, animal, etc.). These properties can be determined on the basis of the sensor data recorded using the sensor system 131.

Variable (current) properties of a road user 120 may comprise: a position and/or movement data relating to the road user 120; relative movement data relating to the road user 120, in particular relative to the ego vehicle 100; a current driving style (for example increments from a position which does not vary very much with respect to the surrounding road users to active, continuous maneuvering, etc.) of the road user 120; a safety distance which is appropriate for the current traffic situation or for the current driving mode; information relating to active functions of the road user 120, in particular with respect to light functions; maneuvering information, in particular automatically detected maneuvers carried out by the road user 120, or the detected intention to carry out a (particular) maneuver; and/or a signaling status of the road user 120 (turn signal actuation, light or audio signals, etc.).

Relative (with respect to a particular vehicle) properties of the road user 120 may comprise: the road user 120 drives in a particular arrangement, for example in the blind spot area, parallel, etc., with respect to another vehicle; the road user 120 overtakes another vehicle (or vice versa); the road user 120 heads for the same road area as another vehicle at the same time; etc.

The current or variable properties of at least one road user 120 and one or more permanent properties can be assigned. A combination (that is to say an active assignment) of database information (relating to permanent properties) with current properties recorded by means of sensors can be used to provide extended information relating to a road user 120.

The method may also comprise transmitting a query from a vehicle 110, the query being dependent on the second set of properties. The data in the query may be, for example, a digitized form of the first set of properties or information derived therefrom. In particular, the query may comprise an item of information relating to the interdependencies of properties in the second set of properties. That is to say, it is not necessary to transmit the entire second set of properties, but rather only information relating to dependencies, in particular relating to correlations, between the properties can possibly be transmitted.

Queries are preferably at least primarily transmitted by the vehicle 110 with respect to particular road users 120 which are or may be relevant to the movement of the vehicle 110 in the near future. The query can be transmitted directly or indirectly to the external unit 130, 131.

Alternatively or additionally, a particular property of a particular road user 120 (detected and/or selected using systems or devices of the vehicle 110) can be transmitted.

A suitable first set of properties (and, on the basis of this, also further properties) of the road user 120 can then be assigned to the transmitted information.

In response to the reception of at least one query relating to at least one road user 120, data relating to one or more road users associated with the road user 120 according to predetermined criteria can be provided. In other words, the vehicle 110 can query information for a particular road user 120 in a query. Furthermore, information relating to one or more additional associated road users 120 can then be made available to the vehicle 110.

In this case, the one or more associated road users 120 may be road users 120 having a predetermined association with the (queried) road user 120. The predetermined association may preferably be: a current distance or a distance to be expected in the near future (radius of 10, 20 or 100 meters); and/or an arrangement (leading vehicle, trailing vehicle, traveling in a parallel manner, etc.) or a particular formation; and/or a movement (overtaking vehicle, a vehicle to be overtaken, etc.); and/or (probable) one-sided or mutual influence during a maneuver; and/or overlapping of precalculated trajectories in the near future; a road user 120 not visible from the point of view of the vehicle sensor system 112 of the vehicle 110 and/or the driver of the vehicle 110 with a high degree of probability (for example the road user is in a blind spot or is approaching quickly); and/or a road user 120 which could be concealed for the ego vehicle 110 by the queried road user 120.

Road users 120 associated with a particular road user 120 can be determined using the means 130, 131 outside the vehicle 110. This is advantageous since associated road users 120 can be determined reliably and in a resource-efficient manner via the perspective of the means 130, 131 outside the vehicle.

The data (for example the first set of properties of the at least one road user 120) received in the vehicle 110 can be compared with the second set of properties of the road user 120. In this case, the data relating to a direct environment, in particular relating to the road users 120 associated with the vehicle 110, available inside the vehicle 110 are preferably completed. It is particularly useful to compare or merge the properties recorded from different perspectives (outside perspective and vehicle's own perspective).

An environmental model of the vehicle 110 can be determined or updated on the basis of the received data relating to the at least one road user 120. In this case, an environmental model which has been completed and/or defined more precisely and/or the plausibility of which has been checked can be determined in comparison with an environmental model based only on a vehicle sensor system 112. On the basis of an environmental model determined in this manner, the following can be determined: movement planning of the vehicle 110 within the scope of at least partially automated driving; and/or road areas which can be traveled on and/or should be avoided by the vehicle 110, in particular at particular intervals of time.

The control unit 111 of the vehicle 110 may be set up to output an item of driver information for the driver of the vehicle 110, which item of driver information is associated with the one or more relevant or associated road users 120. For example, it is possible to output handling instructions, in particular with a relationship to a particular road user 120; and/or warnings, in particular with a relationship to a particular road user 120. In this case, the road user 120 may be, in particular, a road user 120 outside the field of vision of the driver of the vehicle 110.

A first set of properties of at least one road user 120 can primarily be recorded or provided using means 130, 131 outside the vehicle 110 with respect to at least one particular road user 120, to which the information in a query belongs and/or which is associated with such a road user 120.

In other words, the external unit 130, 131 may be set up to primarily record or provide properties relating to road users 120 indicated by a dedicated query from a vehicle 110 or associated with a road user 120 mentioned therein.

The recording of the properties of road users 120 by systems or devices 130, 131 outside the vehicle 110 can therefore be improved and/or focused. In particular, the resources of the systems or devices 130, 131 outside the ego vehicle 110 can be advantageously managed and the real-time capability can be increased. Furthermore, the amount of transmitted data can be reduced.

The query transmitted by the vehicle 110 may comprise an item of information which indicates one or more particular properties of the road user 120 which are intended to be provided by the systems or devices 130, 131 outside the vehicle 110. In other words, the vehicle 110 can be set up to query particular properties or types of properties (for example those properties which cannot be readily recorded by the vehicle 110 itself, for example in prevailing weather conditions or on account of an unfavorable perspective). The systems or devices or apparatus 130, 131 outside the vehicle 110 can then primarily record and provide the queried properties relating to the queried and/or associated road users 120.

For example, on the basis of a comparison or an assignment of at least one first set of properties of a road user 120 with or to a second set of properties of the road user 120, particular properties of the road user 120 which cannot be determined by means of sensors from the current geometrical arrangement of the road users can be determined in the method 200. Such properties can then be provided in the vehicle 110, in particular for a vehicle function. In addition, at least one item of control information for a vehicle function, for example in a remote computing unit, can be determined on the basis of the determined properties and can be wirelessly transmitted to the vehicle 110.

For example, further properties recorded using systems or devices 112 of the vehicle 110, in particular relating to another (complementary) side of the road user 120, can be retrieved in this case or effected from a different recording perspective. In this case, it is not necessary to accurately identify the road user 120.

The described method 200 can comprise determining and providing a third set of properties. The third set of properties may comprise compared properties in connection with at least one assigned road user 120. The third set of properties can be provided for the vehicle 110 or for at least one other road user 120.

In this case, the third set of properties may represent the following data, for example: properties which are missing or are not adequately represented in the second set of properties; properties which are confirmed by the properties in the first set of properties; properties which contradict the properties of the first set of properties; and/or properties merged from the properties of the first set of properties and from the properties of the second set of properties according to a predetermined method.

The third set of properties can be made available to one or more vehicles and/or to a computing unit which is used to influence a plurality of vehicles, in particular maneuvering decisions, route planning or movement trajectories. The third set of properties may also be transmitted to the vehicle 110 itself

The following advantages therefore result: the amount of information to be transmitted is considerably reduced in comparison with interchanging the complete first/second sets. The reduced information can therefore be transmitted more quickly. Furthermore, a (comparatively cost-effective) computing unit in an infrastructure apparatus relieves the load on the control devices in individual vehicles. In addition, the provision can be effected by means of wireless transmission, for example by means of WLAN, LTE, 3G, etc., for example from a router on a freeway bridge. The memory in which the data relating to the properties of the road users 120 are provided may likewise be in such a router.

At least part of the method 200 can be carried out on a user terminal (for example on a smartphone, a tablet, etc.), the user terminal being able to be connected to the vehicle 110 by means of a wired or wireless communication connection. For example, the communication unit, the sensor system and/or the computing resources of a user terminal can therefore be used, which makes it possible to efficiently implement the method 200.

The method 200 can be used, in particular, in connection with: at least partially automated driving of the vehicle 110; at least partially automated signaling of the vehicle 110 to the vehicle environment; and/or at least partially automated parking of at least one or more vehicles. In particular, the method 200 can be applied to a plurality of vehicles or road users in a particularly useful manner.

Furthermore, this document describes systems or devices 111, 112 inside a vehicle 110, systems or devices 130, 131 outside the vehicle 110 and one or more corresponding computer program products.

The method 200 described in this document has a multiplicity of advantages. In particular, the method 200 provides data relating to surrounding road users 120 which were previously not available and can be efficiently determined. It is therefore possible to support a high degree of automation or a particularly constant degree of automation, for example during highly automated driving, with low risks. The method 200 can also be used for a number of further (comfort, infotainment and light) functions. The method 200 results in cost advantages because the method 200 can also be used for vehicles having a relatively simple sensor system. Furthermore, cost advantages result since it is possible to use external computing resources (for example in an external router) which are typically more favorable than vehicle computing resources. In addition, the method 200 can also be used with already available vehicles (without hardware retrofitting).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for assigning sets of properties of one or more road users, the method comprising the acts of:
recording a first set of properties of a road user at a first instant of time using one or more systems or devices of a vehicle and/or using one or more systems or devices outside the vehicle;
recording a second set of properties of a road user at a second instant of time, which is after the first instant of time;
comparing the properties of the first set and the properties of the second set;
determining an assignment of the first and second sets to an assigned road user on the basis of the comparison; and
providing the assignment.

2. The method as claimed in claim 1, further comprising the act of:
determining a property of the assigned road user, which cannot be recorded to a required extent at the second instant of time, on the basis of the assignment.

3. The method as claimed in claim 1, wherein:
a period of 5, 10, 20, 30, 60 seconds or more lies between the first instant of time and the second instant of time; and/or
properties of the assigned road user are not recorded at least temporarily between the first instant of time and the second instant of time.

4. The method as claimed in claim 1, wherein:
the comparison and/or the determination of an assignment comprises the recognition of a road user; and/or
a process of tracking the assigned road user is carried out on the basis of the assignment.

5. The method as claimed in claim 1, further comprising the act of:
determining a third set of properties of the assigned road user on the basis of the comparison; and
providing the third set in the vehicle and/or in another road user.

6. The method as claimed in claim 1, wherein, the comparison of the properties of the first set and the properties of the second set comprises the acts of:
determining a degree of similarity,
determining one or more statistical dependencies between the properties, and/or
determining a degree of plausibility.

7. The method as claimed in claim 1, wherein the comparison and the determination of an assignment comprises the act of:
determining a machine-trained allocation function, in the form of a neural network, which is set up to determine whether or not a first set of the properties and a second set of properties belong to the same road user.

8. The method as claimed in claim 1, wherein,
the comparison and the determination of an assignment comprises determining a data model for a road user; and
the assignment is determined on the basis of the data model.

9. The method as claimed in claim 8, wherein a data model indicates probabilities for combinations of the properties.

10. The method as claimed in claim 9, wherein the comparison and the determination of an assignment are carried out on the basis of a multiplicity of data models for different combinations of the properties.

11. The method as claimed in claim 1, further comprising the act of:
determining an input variable for at least one vehicle function of the vehicle on the basis of the comparison and/or the assignment.

12. The method as claimed in claim 1, wherein the first set and/or the second set comprise properties from one or more of the following categories:
geometrical data relating to a road user;
color information relating to a road user;
information relating to the clothing of a pedestrian or a driver of a vehicle;
a class or a vehicle model of a road user;
information relating to a vehicle brand of a road user.

13. The method as claimed in claim 1, wherein the first set and/or the second set comprise properties from one or more of the following categories:
absolute and/or relative position data relating to a road user;
absolute and/or relative movement data relating to a road user;
geometrical arrangement data relating to a road user relative to at least one other road user.

14. The method as claimed in claim 1, wherein the first set and/or the second set of properties comprise one or more of:
information relating to a license number of a road user;
information relating to a vignette of a road user;
information relating to an electronic device which is moved with the road user.

15. The method as claimed in claim 1, wherein the first set and the second set at least partially comprise different properties from different categories.

16. The method as claimed in claim 1, wherein an assignment is determined on the basis of data which indicate which road users are in a particular road section.

17. The method as claimed in claim 1, wherein the first set of properties at least partially is determined by querying a database outside the vehicle and/or by comparing data from a multiplicity of systems or devices outside the vehicle.

18. The method as claimed in claim 1, wherein:
the first and/or the second set of properties of a road user have one or more permanent properties and one or more variable properties; and
an assignment is determined on the basis of the one or more variable properties and on the basis of the one or more permanent properties.

19. The method as claimed in claim 1, wherein:
the method also comprises transmitting a query message by the vehicle; and
the query message comprises information which depends on the first set of properties.

20. The method as claimed in claim 19, wherein first sets of one or more road users primarily are provided by the systems or devices outside the vehicle in response to the query message, which sets are indicated in the query message or are associated with an indicated road user.

21. The method as claimed in claim 20, wherein the query message indicates one or more properties which are intended to be recorded by the systems or devices outside the vehicle.

22. The method as claimed in claim 1, further comprising the acts of:
determining one or more associated road users associated with the assigned road user; and
providing data for the one or more associated road users.

23. The method as claimed in claim 1, further comprising the acts of:
comparing the first set of properties with the second set of properties; and/or
creating an environmental model of the vehicle on the basis of the first and second sets of properties.

24. The method as claimed in claim 1, wherein the first and second sets of properties are used by the vehicle:
to drive the vehicle at least partially in an automatic manner;
to output an item of driver information to a driver of the vehicle; and/or
to output a handling instruction and/or a warning with respect to the assigned road user and/or with respect to an associated road user to the driver of the vehicle.

25. A computer program product comprising a computer readable medium having stored thereon on program code segments that, when executed, cause a processor to:
record a first set of properties of a road user at a first instant of time using systems or devices of a vehicle and/or using systems or devices outside the vehicle;
record a second set of properties of a road user at a second instant of time, which is after the first instant of time;
compare the properties of the first set and the second set;
determine an assignment of the first and second sets to an assigned road user based on the comparison; and
output the assignment.

26. A system for assigning sets of properties of one or more road users, the system comprising one or more computers and associated memory having stored thereon program code segments that, when executed, cause the one or more computers to:
record a first set of properties of a road user at a first instant of time using systems or devices of a vehicle and/or using systems or devices outside the vehicle;
record a second set of properties of a road user at a second instant of time, which is after the first instant of time;
compare properties of the first set and the second set;
determine an assignment of the first and second sets to an assigned road user based on the comparison; and
output the assignment.
